(19) United States
(12) Patent Application Publication
(10) Pub. No.: US 2005/0235042 A1
(43) Pub. Date: Oct. 20, 2005

(54) Media card companion

(76) Inventors: Todd J. Rumaner, Livermore, CA (US); Shu Chen, Fremont, CA (US); Michael G. Mulqueen, San Ramon, CA (US)

Correspondence Address: PATENT LAW GROUP LLP, 2635 NORTH FIRST STREET, SUITE 223, SAN JOSE, CA, 95134, US

(21) Appl. No.: 10/826,109

(22) Filed: Apr. 16, 2004

(51) Int. Cl. G06F 15/167

(52) U.S. Cl. 709/216

(57) ABSTRACT

A method for a memory device utility program includes (1) detecting a memory device being coupled to a host device, (2) in response to said detecting, locating files on the memory device, (3) displaying a file transfer page comprising a file transfer button for transferring the files on the memory device to the host device, and (4) in response to a user selecting the transfer button, transferring the files on the memory device to the host device.

### FIELD OF INVENTION

This invention relates to utility software for transferring files from a memory device to a host device.

### DESCRIPTION OF RELATED ART

A memory card (also known as a “media card”) is a removable module used for storing files in a portable device such as a digital camera or a music player. The memory card is made up of non-volatile flash memory chips in various formats such as CompactFlash, SmartMedia, and Memory Stick. Similarly, a removable storage device (e.g., Thumbdrives™) can also be used to transport files such as digital photos and music but are usually not used inside digital cameras or music players.

To transfer the files to a computer, the portable device or the removable storage device is coupled by a physical connection (e.g., a USB connection by cable or by directly plugging in the device into a USB port) or through a wireless connection (e g., a WiFi, IR, or a Bluetooth connection) to the computer. Alternatively, the memory card is removed from the portable device and inserted into a memory card reader coupled to the computer.

After being coupled, the computer detects the presence of the memory device and generates an appropriate icon representing the memory device (e.g., as a removable drive on the computer). The user then selects the icon, typically by clicking the icon, to see a list of directories and files on the memory device. The user then searches the list for files to be transferred to the computer. The file transfer process often involves the user selecting a source directory on the memory device, selecting one or more files in the source directory, selecting a destination directory on the computer, instructing the computer to copy the selected files from the source directory to the destination directory, and instructing the computer to delete the selected files from the memory device. The file transfer process is laboriously repeated as the user searches through multiple directories.

After the file transfer, the user would typically like to rename the files to give them a more descriptive file name. For example, when a digital camera adds pictures to a media card, the files are usually named as a series of sequential numbers, which are totally cryptic and meaningless to the user. After transferring the pictures to a computer, the user would then rename the photos individually. Because this process is not easy, the user may often just create a folder with a descriptive name and leave the cryptic names for the picture files.

Thus, what is needed is a method for improving the file transfer process described above.

### BRIEF DESCRIPTION OF THE DRAWINGS

FIG. 1 illustrates a computer connected to a memory card reader and a portable device having a memory card in one embodiment of the invention.

FIG. 2 illustrates a map of the windows displayed by a utility software in one embodiment of the invention.

FIG. 3 illustrates a start window displayed by the utility software in one embodiment of the invention.

FIG. 4 illustrates a file transfer window displayed by the utility software in on embodiment of the invention.

FIG. 5 illustrates a transfer report window displayed by the utility software in one embodiment of the invention.

FIG. 6 illustrates a photo tool window displayed by the utility software in one embodiment of the invention.

FIGS. 7 to 13 illustrate pages in a tool setup window displayed by the utility software in embodiments of the invention.

FIG. 14 illustrates a tool report window displayed by the utility software in one embodiment of the invention.

Use of the same reference numbers in different figures indicates similar or identical elements.

### SUMMARY

In one embodiment of the invention, a method for a memory device utility program includes (1) detecting a memory device being coupled to a host device, (2) in response to said detecting, locating files on the memory device, (3) displaying a file transfer page comprising a file transfer button for transferring the files on the memory device to the host device, and (4) in response to a user selecting the transfer button, transferring the files on the memory device to the host device.

### DETAILED DESCRIPTION

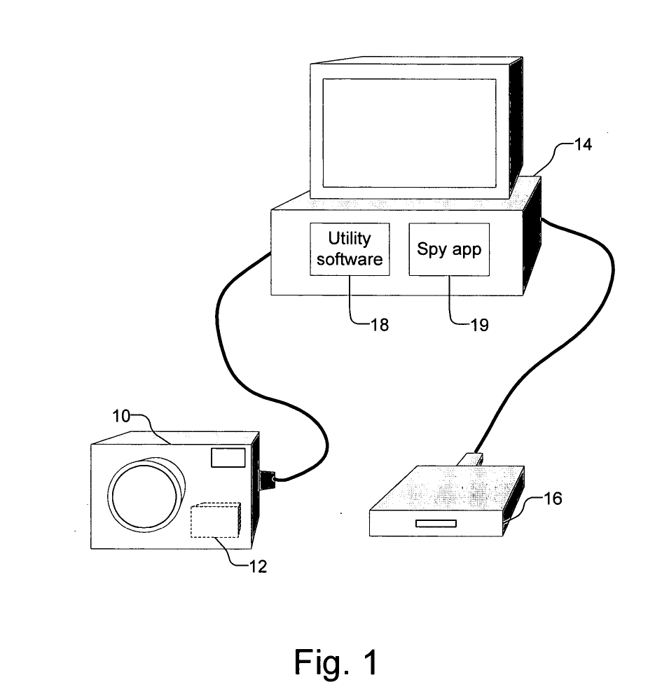

FIG. 1 illustrates a portable device 10 (e.g., a digital camera) having a memory card 12 coupled to a host device 14 (e.g., a computer) by a cable or a wireless connection. Memory card 12 can also be removed from digital camera 10 and inserted into a memory card reader 16 coupled to computer 14. In one embodiment, a utility software 18 is installed on computer 14. Alternatively, utility software 18 is stored on memory card 12 to be executed by computer 14. Utility software 18 helps to transfer and rename files from memory card 12 to computer 14. Utility software 18 may also help to print photos, print index pages of the photos, order prints of the photos online, email proof sheets of the photos, and create or update a screensaver with the photos.

When installed on computer 14, utility software 18 includes a small spy application 19 used to detect the presence of memory card 12 on computer 14. Once it detects the presence of memory card 12, spy application 19 determines if there are files on memory card 12. If there are files on memory card 12, spy application 19 launches utility software 18.

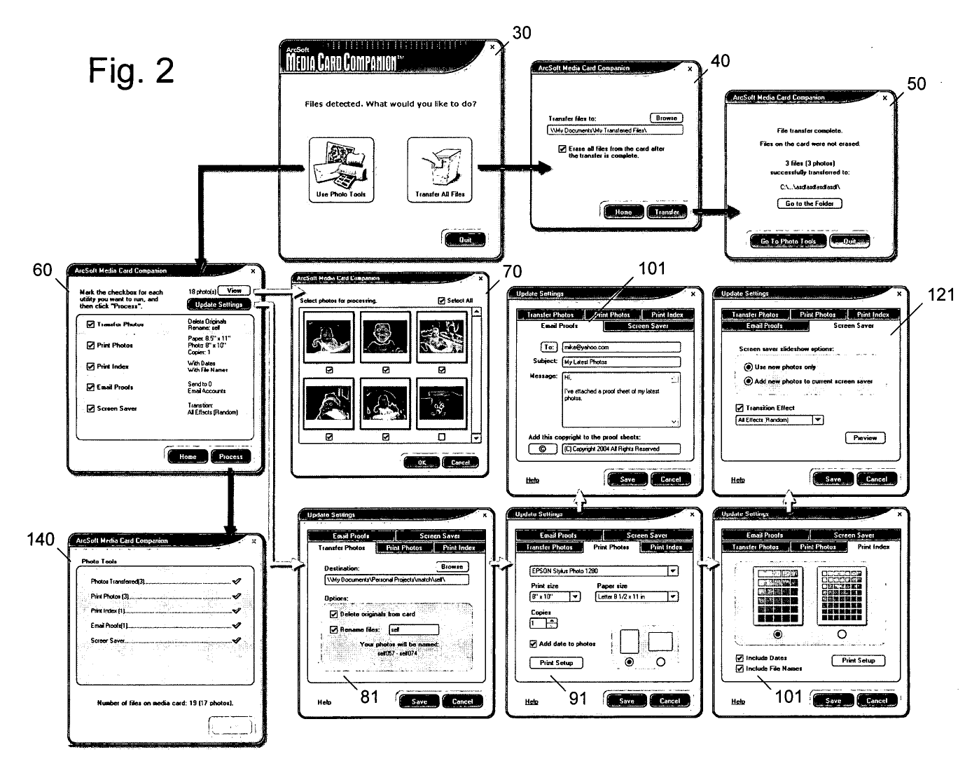

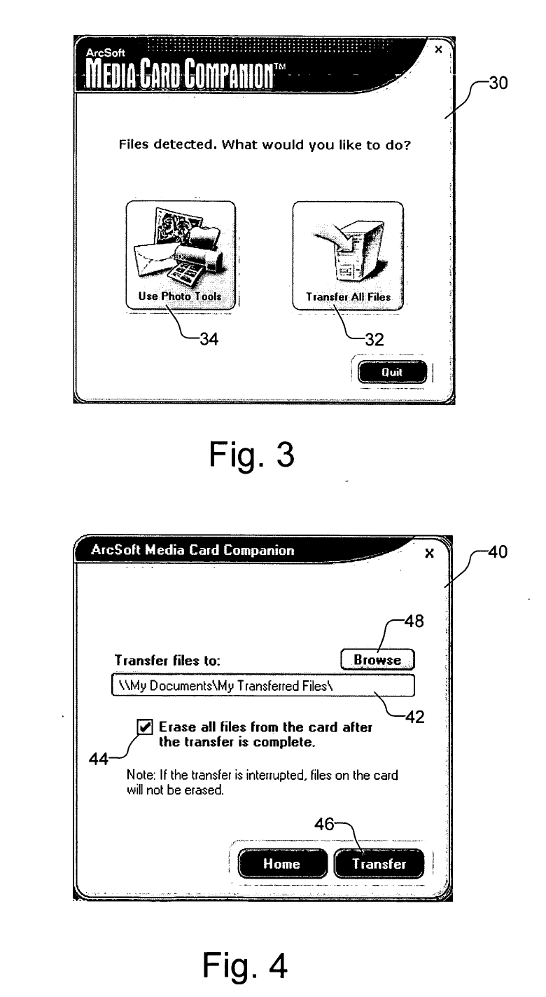

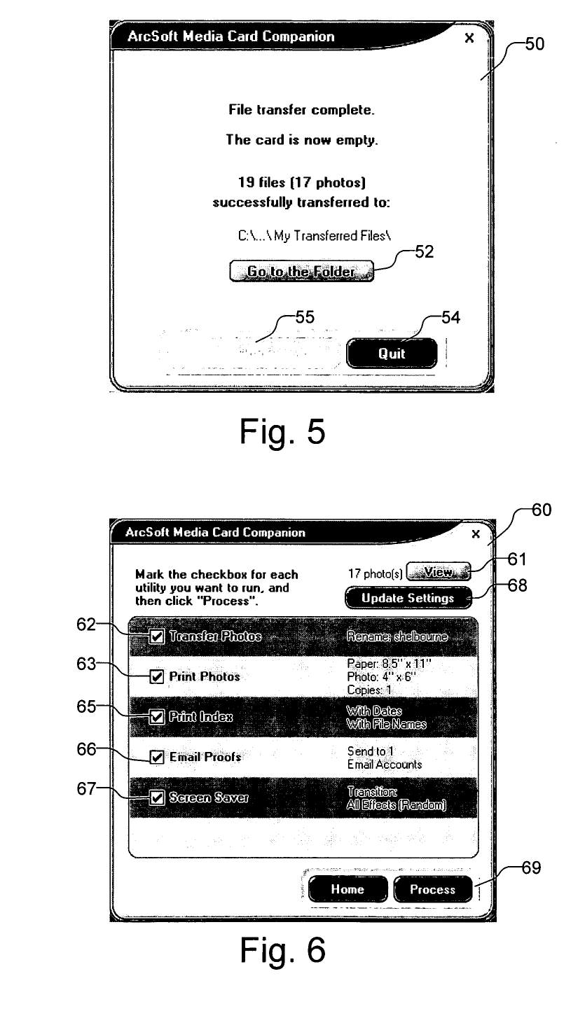

FIG. 2 illustrates a map of the various windows displayed by utility software 18 in one embodiment of the invention. Once launched, utility software 18 will display a start window 30 (FIG. 3) if there are photo files on memory card 12. Photo files are files having formats including JPEG, TIFF, BMP, FPX, PCD, PCX, PNG, PSD, PSF, and TGA. Alternatively, if there are no photo files on memory card 12, utility software 18 will display a file transfer window 40 (FIG. 4).

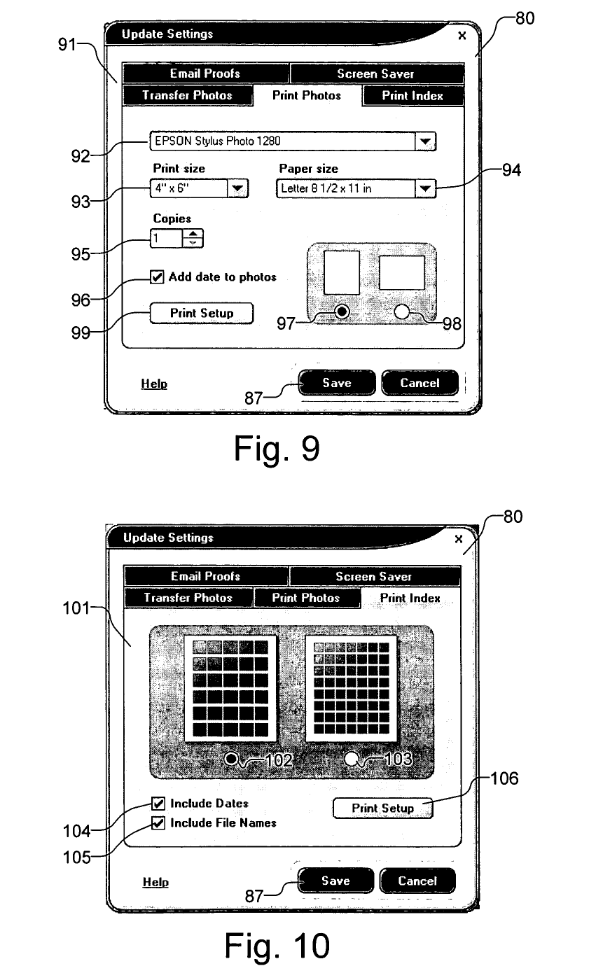

FIG. 3 illustrates start window 30 in one embodiment of the invention. Start window 30 includes a file transfer button 32 and a photo tool button 34. Utility software 18 will display file transfer window 40 (FIG. 4) if the user selects file transfer button 32. Alternatively, utility software 18 will display an image tool window 60 (FIG. 6) if the user selects photo tool button 34.

FIG. 4 illustrates file transfer window 40 in one embodiment of the invention. File transfer window 40 includes a destination textbox 42, a deletion checkbox 44, and a transfer initiation button 46. Destination textbox 42 lists a default destination folder on computer 14 for storing the files from memory card 12. The user may edit the destination folder or select a browse button 48 to launch a browser window to select another destination folder. Deletion checkbox 44 allows the user to instruct utility software 18 to delete the files on memory card 12 after they have been transferred to the destination folder on computer 14. When the user selects transfer initiation button 46, utility software 18 copies all the files on memory card 12 to the destination folder on computer 14 and optionally deletes the original files on memory card 12. To copy and delete the files, utility software 18 uses the system API on computer 14 to manipulate files and folders.

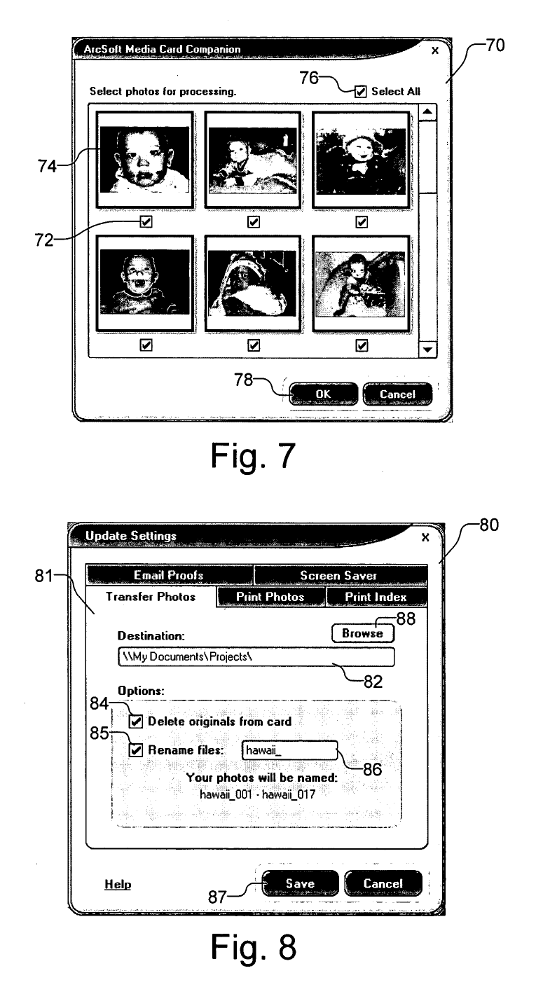

After the file transfer is completed, utility software 18 displays a transfer report window 50. FIG. 5 illustrates transfer report window 50 in one embodiment. Transfer report window 50 lists the number of files that were transferred versus the number of photos on memory card 12, the destination folder on computer 14, and the status of memory card 12 (e.g., empty) if the user has instructed utility software 18 to delete the files on memory card 12 after the transfer. Transfer report window 50 further includes a folder button 52, an exit button 54, and a photo tool button 55. Utility software 18 will open an explorer window to the destination folder on computer 14 if the user clicks folder button 52. Utility software 18 will close if the user clicks exit button 54. After utility software 18 is closed, spy application 19 will remain to detect the presence of another memory card 12 on computer 14. Utility software 18 will display photo tool window 60 (FIG. 6) if the user selects photo tool button 55. If there are no photos on memory card 12, then photo tool button 55 will be unavailable.

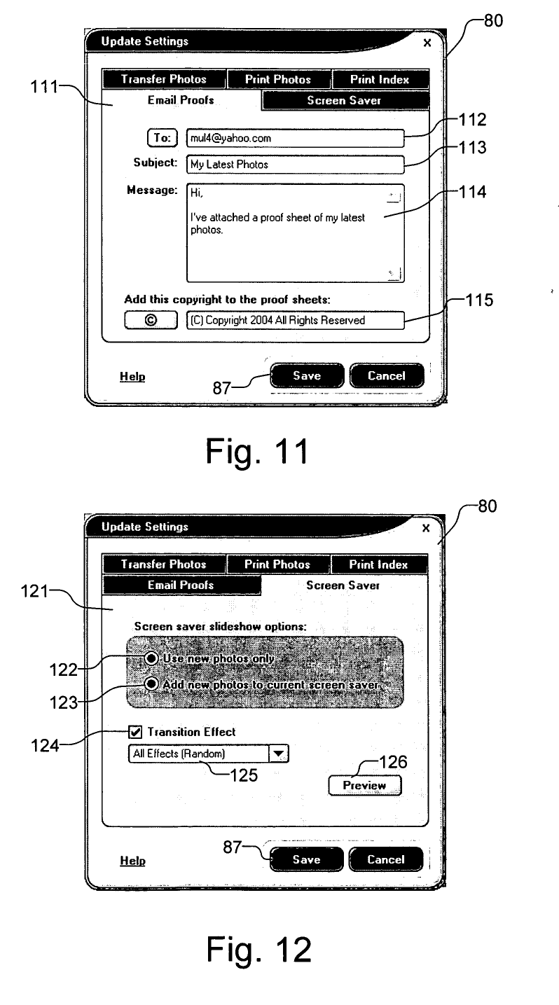

FIG. 6 illustrates photo tool window 60 in one embodiment. Photo tool window 60 includes a view button 61, a transfer photo checkbox 62, a print photo checkbox 63, a print index checkbox 65, an email proof checkbox 66, a screensaver checkbox 67, a tool setting button 68, and a process button 69. If the user wishes to select fewer than all the photos on memory card 12, the user would click view button 61. In response, utility software 18 will display a thumbnail window 70 (FIG. 7). If the user wishes to use any of the tools, the user would check the corresponding checkboxes and then click process button 69. In response, utility software 18 will apply the checked tools to the selected photos. To setup each tool, the user clicks tool setting button 68. In response, utility software 18 displays a setup window 80 (FIGS. 8 to 12).

FIG. 7 illustrates a thumbnail window 70 in one embodiment of the invention. The user selects photos by clicking checkboxes 72 (only one is labeled) below thumbnails 74 (only one is labeled) of the photos or by clicking checkbox 76 to select all the photos, and then clicking an OK button 78 to proceed. In response, utility software notes the selected photos and redisplays photo tool window 60 (FIG. 6). In one embodiment, utility software 18 includes conventional imaging software for generating, if necessary, and displaying the thumbnails. Alternatively, utility software 18 instructs conventional imaging software installed on computer 14 to generate the thumbnails.

FIG. 8 illustrates tool setup window 80 with the transfer photo page 81 selected in one embodiment of the invention. Transfer photo page 81 includes a destination textbox 82, a deletion checkbox 84, a rename checkbox 85, a prefix textbox 86, and a save button 87. Destination textbox 82 lists a default destination folder on computer 14 for storing the photos from memory card 12. The user may edit the destination folder or select a browse button 88 to launch a browser window to select another destination folder. Deletion checkbox 84 allows the user to instruct utility software 18 to delete the photos on memory card 12 after they have been transferred to the destination folder on computer 14. Rename checkbox 85 allow the user to instruct utility software 18 to rename the photos with a common prefix (e.g., “vacation”). All the photos will be saved with the common prefix and incrementing suffixes (e.g., “vacation00l” to “vacation025”). The user may edit the common prefix in prefix textbox 86. Transfer photo page 81 may optionally include a suffix spin box for setting a starting number for the incrementing suffixes, and a conversion checkbox and a drop-down list for converting the selected photos to a selected format after the transfer. When the user selects save button 87, utility software 18 saves the current settings for all the tools and redisplays tool window 60 (FIG. 6). The user may select the setting of another tool by clicking the corresponding tab at the top of window 80. To copy, rename, and delete the files, utility software 18 uses the system API on computer 14 to manipulate files and folders.

FIG. 9 illustrates tool setup window 80 with print photo page 91 selected in one embodiment of the invention. Print photo page 91 includes a drop-down list box 92 for selecting a printer, a drop-down list box 93 for selecting a print size, a drop-down list 94 for selecting a paper size, a spin box 95 for setting the number of print copies, a checkbox 96 for printing the dates of the photos on the prints, radio buttons 97 and 98 for selecting the orientation of the paper, and a print setup button 99 for configuring the selected printer. In one embodiment, utility software 18 includes conventional imaging software for printing the photos according to the settings provided by the user. Alternatively, utility software 18 uses the system API to instruct conventional imaging software installed on computer 14 to print the photos according to the settings provided by the user.

FIG. 10 illustrates tool setup window 80 with print index page 101 selected in one embodiment of the invention. Index photo page 101 includes radio buttons 102 and 103 for selecting the number of photos to be included in one index page, a checkbox 104 for printing the dates of the photos on the index page, a checkbox 105 for printing the file names of the photos on the index page, and a print setup button 106 for configuring the selected printer. In one embodiment, utility software 18 includes conventional imaging software for printing the index pages according to the settings provided by the user. Alternatively, utility software 18 uses the system API to instruct conventional imaging software installed on computer 14 to print the index pages according to the settings provided by the user.

FIG. 11 illustrates tool setup window 80 with email proof page 111 selected in one embodiment of the invention. Email proof page 111 includes a recipient textbox 112 for typing the email addresses for those receiving the proofs, a subject textbox 113, a message textbox 114, and a copyright textbox 115 for adding copyright warnings onto the proofs. Email proof page 111 may optionally include radio buttons for reducing the size of the selected proofs to be emailed to the recipients. In one embodiment, utility software 18 uses the system API to instruct the conventional email software installed on computer 14 to email the proofs according to the settings provided by the user.

FIG. 12 illustrates tool setup window 80 with screensaver page 121 selected in one embodiment of the invention. Screensaver page 121 includes a radio button 122 for creating a new screensaver with the selected photos, a radio button 123 for inserting the selected photos in the current screensaver, a transition checkbox 124 for using a transition effect between photos, a drop-down list box 125 for selecting the transition effect, and a preview button 126 for previewing the screensaver. In one embodiment, utility software 18 uses the system API to instruct the conventional screensaver software installed on computer 14 to generate the screensaver according to the settings provided by the user.

After applying the checked tools to the selected photos, utility software 18 displays a tool report window 140. FIG. 13 illustrates tool report window 140 in one embodiment of the invention. Tool report window 140 lists the number of photos transferred to the destination folder on computer 14, the number of photos printed, the number of index pages printed, the number of recipients that proofs have been emailed, the status of the screensaver (e.g., updated), and the total number of files on memory card 12 versus the number of photo files on memory card 12. The user can click a home button 142 and in response utility software 18 will redisplay start window 30 for the user to transfer the non-photo files from memory card 12 to computer 14. Alternatively, the user can exit utility software 18 by clicking a quit button 144.

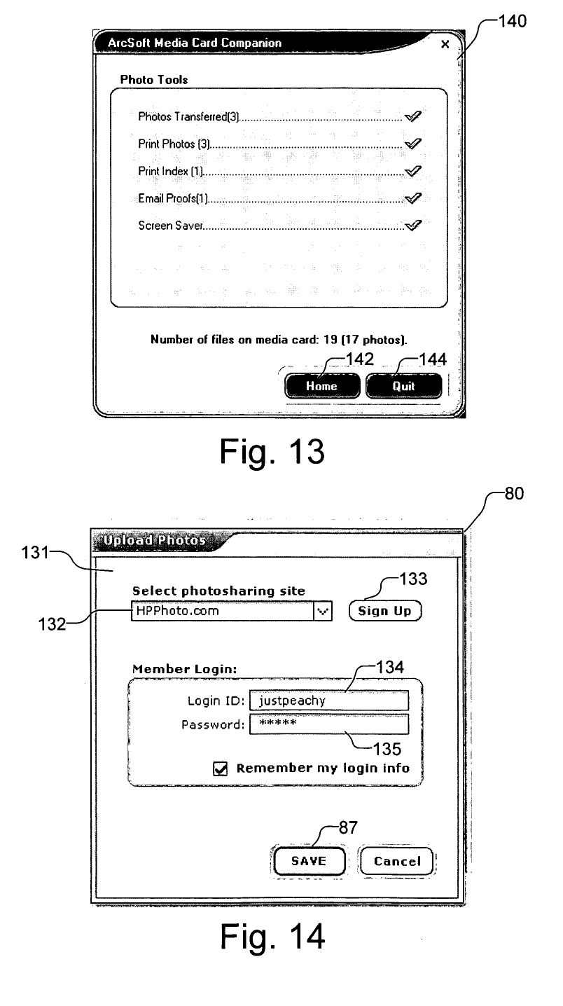

FIG. 14 illustrates tool setup window 80 with an optional order print page 131 selected in one embodiment of the invention. Order print page 131 includes a drop-down list box 132 of websites where prints can be ordered, a signup box 133 for registering with a website, a login ID textbox 134, and a login password textbox 135. In one embodiment, utility software 18 is conventionally configured to communicate the required login and upload the order and the photos to various websites.

Various other adaptations and combinations of features of the embodiments disclosed are within the scope of the invention. Although the invention has been described above with a memory card, the invention is applicable to other memory devices including removable storage devices such Thumbdrives™. Numerous embodiments are encompassed by the following claims.

1. A method for a memory device utility program, the method comprising
detecting a memory device being coupled to a host device;
in response to said detecting, locating files on the memory device;
displaying a file transfer window comprising a file transfer button for initiating a transfer of the files on the memory device to the host device; and
in response to a user clicking the transfer button, transferring the files on the memory device to the host device.

2. The method of claim 1, wherein said being coupled is selected from the group consisting of a physical connection and a wireless connection.

3. The method of claim 1, wherein the file transfer window further comprises a textbox with a destination on the host device where the files are to be stored.

4. The method of claim 3, wherein the file transfer window further comprises a deletion checkbox for deleting the files on the memory device after said transferring, the method further comprising:
in response to a user checking the deletion checkbox, deleting the files on the memory device after said transferring.

5. The method of claim 1, further comprising, after said locating files and prior to said displaying a file transfer page:
in response to locating the files, displaying a start window comprising (1) a photo tool button prompting the user to apply photo tools to photos on the memory device, and (2) another file transfer button prompting the user to transfer the files on the memory device to the host device, wherein the file transfer page is displayed in response to the user clicking said another file transfer button.

6. The method of claim 5, further comprising:
in response to the user clicking the photo tool button, displaying a photo tool window comprising (1) a selection button for launching a thumbnail page for selecting the photos on the memory device, and (2) a process button for initiating one or more photo tools.

7. The method of claim 6, wherein the photo tool window further comprises (3) a file transfer checkbox and (4) a setup button for launching a setup window, wherein the method further comprises:
transferring selected photos on the memory device to the host device after the user checks the file transfer checkbox and clicks the process button.

8. The method of claim 7, wherein the setup window comprises (1) a destination textbox with a destination on the host device where the selected photos are stored, (2) a deletion checkbox for deleting the selected photos on the memory device after said transferring, (3) a rename checkbox for renaming the selected photos with file names having a common prefix and incrementing suffixes, and (4) a prefix textbox with the common prefix.

9. The method of claim 8, wherein setup window further comprises (5) a conversion checkbox for enabling a conversion of the selected photos to a selected format after said transferring, (6) a drop-down list box for selecting the format, and (7) a suffix textbox with a starting suffix number.

10. The method of claim 6, wherein the photo tool window further comprises (3) a print file checkbox and (4) a setup button for launching a setup window, wherein the method further comprises:
printing selected photos after the user checks the print file checkbox and clicks the process button.

11. The method of claim 10, wherein the setup window comprises (1) a first drop-down list for selecting a printer, (2) a second drop-down list box for selecting a print size, (3) a third drop-down list for selecting a paper size, (4) a spin box for setting the number of print copies, (5) a checkbox for including dates on the selected photos, and (6) radio buttons for setting paper orientation.

12. The method of claim 6, wherein the photo tool window further comprises (3) an index page checkbox and (4) a setup button for launching a setup window, wherein the method further comprises:
printing an index page of selected photos after the user checks the index page checkbox and clicks the process button.

13. The method of claim 12, wherein the setup window comprises (1) radio buttons for selecting a layout of the selected photos on each printed index page, (2) a date checkbox for including dates of the selected photos on each printed index page, and (3) a name checkbox for including names of the selected photos on each printed index page.

14. The method of claim 6, wherein the photo tool window further comprises (3) an email checkbox and (4) a setup button for launching a setup window, wherein the method further comprises:
emailing selected photos to a recipient after the user checks the email checkbox and clicks the process button.

15. The method of claim 14, wherein the setup window comprises (1) a recipient textbox for receiving an email address of the recipient, (2) a subject textbox, (3) a message textbox, and (4) a copyright textbox to include a copyright warning on the selected photos.

16. The method of claim 15, wherein the setup window further comprises (5) radio buttons for selecting the size of the selected photos to be emailed to the recipient.

17. The method of claim 6, wherein the photo tool window further comprises (3) an order checkbox and (4) a setup button for launching a setup page, wherein the method further comprises:
ordering prints of selected photos from a website after the user checks the order checkbox and clicks the process button.

18. The method of claim 17, wherein the setup window comprises (1) a drop-down list box of websites, (2) a login ID textbox, (3) a login password textbox, and (4) a signup button for signing up with a new website.

19. The method of claim 6, wherein the photo tool window further comprises (3) a screensaver checkbox and (4) a setup button for launching a setup page, wherein the method further comprises:
including selected photos in a screensaver on the host device after the user checks the screensaver checkbox and clicks the process button.

20. The method of claim 19, wherein the setup window comprises (1) a first radio button for creating a new slideshow with the selected photos, (2) a second radio button for inserting the selected photos into an existing slideshow, (3) a first checkbox for enabling a transition effect, (4) a drop-down list box for selecting the transition effect, and (5) a second checkbox for displaying names of the selected photos in the slideshow.
